(19) United States
(12) Patent Application Publication
(10) Pub. No.: US 2025/0308005 A1
(43) Pub. Date: Oct. 2, 2025

(54) IMAGE PROCESSING APPARATUS AND METHOD, IMAGE CAPTURING APPARATUS, AND STORAGE MEDIUM

(71) Applicant: CANON KABUSHIKI KAISHA, Tokyo (JP)

(72) Inventor: JUNJI TADA, Tokyo (JP)

(21) Appl. No.: 19/083,736

(22) Filed: Mar. 19, 2025

(30) Foreign Application Priority Data
Mar. 29, 2024 (JP) 2024-057615

(51) Int. Cl. G06T 5/92; G06T 7/11

(52) U.S. Cl. CPC G06T 5/92; G06T 7/11; G06T 2207/20208; G06T 2207/30168; G06T 2207/30196

(57) ABSTRACT

An image processing apparatus, comprises at least one processor or circuit configured to function to: acquire an image; divide and classify the image into a plurality of regions based on predefined conditions; determine correction characteristics for correcting tone characteristics for each of the plurality of regions; and correct the tone characteristic of each of the regions using the correction characteristics corresponding to each of the regions. In the determination, the correction characteristics corresponding to one of the plurality of regions that is used as a reference is set as a reference correction characteristics, and for the correction characteristics other than the reference correction characteristics, the correction characteristics of at least a portion that has a luminance lower than a predetermined luminance are determined based on the reference correction characteristics.

### BACKGROUND

### Technical Field

The aspect of the embodiments relate to an image processing apparatus and method, an image capturing apparatus, and a storage medium, and in particular to a method for determining tone correction characteristics for each region having different characteristics in an image.

### Description of the Related Art

Conventionally, tone correction processing, such as high dynamic range synthesis (HDR), dodging, etc., is known in which a signal obtained by expanding a dynamic range of an input signal is subjected to tone compression when being output. In particular, in scenes with a wide dynamic range, a method of performing such tone correction for each region is effective, but on the other hand, the image as a whole becomes unnatural.

Japanese Patent Laid-Open No. 2015-82768 discloses a method of obtaining a representative luminance value and a luminance histogram for each subject region, determining a tone curve for each subject region, and adjusting an amount of compression by the tone curve according to the difference between the representative luminance values of subjects.

In the technology disclosed in Japanese Patent Laid-Open No. 2015-82768, the amount of compression by the tone curve is adjusted based on the difference between the representative luminance values of subjects, so there is a possibility that over-correction or under-correction may occur depending on the luminance distribution of each subject.

### SUMMARY

According to a first aspect of the embodiments, there is provided an image processing apparatus, comprising at least one processor or circuit configured to function to: acquire an image; divide and classify the image into a plurality of regions based on predefined conditions; determine correction characteristics for correcting tone characteristics for each of the plurality of regions; and correct the tone characteristic of each of the regions using the correction characteristics corresponding to each of the regions, wherein, in the determination, the correction characteristics corresponding to one of the plurality of regions that is used as a reference is set as a reference correction characteristics, and for the correction characteristics other than the reference correction characteristics, the correction characteristics of at least a portion that has a luminance lower than a predetermined luminance are determined based on the reference correction characteristics.

Further, according to a second aspect of the embodiments, there is provided an image capturing apparatus comprising: an image sensor; and an image processing apparatus, comprising at least one processor or circuit configured to function to: acquire an image; divide and classify the image into a plurality of regions based on predefined conditions; determine correction characteristics for correcting tone characteristics for each of the plurality of regions; and correct the tone characteristic of each of the regions using the correction characteristics corresponding to each of the regions, wherein, in the determination, the correction characteristics corresponding to one of the plurality of regions that is used as a reference is set as a reference correction characteristics, and for the correction characteristics other than the reference correction characteristics, the correction characteristics of at least a portion that has a luminance lower than a predetermined luminance are determined based on the reference correction characteristics.

Further, according to a third aspect of the embodiments, there is provided an image processing method comprising: acquiring an image; dividing and classifying the image into a plurality of regions based on predefined conditions; determining correction characteristics for correcting tone characteristics for each of the plurality of regions; and correcting the tone characteristic of each of the regions using the correction characteristics corresponding to each of the regions, wherein, in the determining, the correction characteristics corresponding to one of the plurality of regions that is used as a reference is set as a reference correction characteristics, and for the correction characteristics other than the reference correction characteristics, the correction characteristics of at least a portion that has a luminance lower than a predetermined luminance are determined based on the reference correction characteristics.

Further, according to a fourth aspect of the embodiments, there is provided a non-transitory computer-readable storage medium storing instructions that, when executed by one or more processors, cause the one or more processors to perform a method comprising: acquiring an image; dividing and classifying the image into a plurality of regions based on predefined conditions; determining correction characteristics for correcting tone characteristics for each of the plurality of regions; and correcting the tone characteristic of each of the regions using the correction characteristics corresponding to each of the regions, wherein, in the determining, the correction characteristics corresponding to one of the plurality of regions that is used as a reference is set as a reference correction characteristics, and for the correction characteristics other than the reference correction characteristics, the correction characteristics of at least a portion that has a luminance lower than a predetermined luminance are determined based on the reference correction characteristics.

Further features of disclosure will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the disclosure, and together with the description, serve to explain the principles of the disclosure.

FIG. 1 is a block diagram illustrating a schematic functional configuration of an image capturing apparatus according to first and second embodiments.

FIG. 2 is a block diagram illustrating a functional configuration of an image processing unit according to the first embodiment.

FIG. 3 is a flowchart illustrating by-region tone correction processing according to the first embodiment.

FIG. 4 is a flowchart illustrating an example of a method for calculating tone compression characteristics of a subject region according to the first embodiment.

FIG. 5 is a diagram explaining a method for calculating a representative luminance value of a face region according to the first embodiment.

FIG. 6 is a diagram explaining a method for determining a highlight luminance value of a person region according to the first embodiment.

FIG. 7 is a diagram explaining a method for determining tone compression characteristics of a subject region according to the first embodiment.

FIG. 8 is a flowchart illustrating an example of a method for calculating tone compression characteristics of a background region according to the first embodiment.

FIG. 9 is a diagram explaining a method for determining a dark portion representative luminance value of the background region according to the first embodiment.

FIGS. 10A to 10C are diagrams explaining a method for calculating the tone compression characteristics of the background region according to the first embodiment.

FIG. 11 is a diagram explaining a method for determining the tone compression characteristics of the background region according to the first embodiment.

FIG. 12 is a block diagram illustrating a functional configuration of an image processing unit according to the second embodiment.

FIG. 13 is a flowchart illustrating by-region tone correction processing according to the second embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

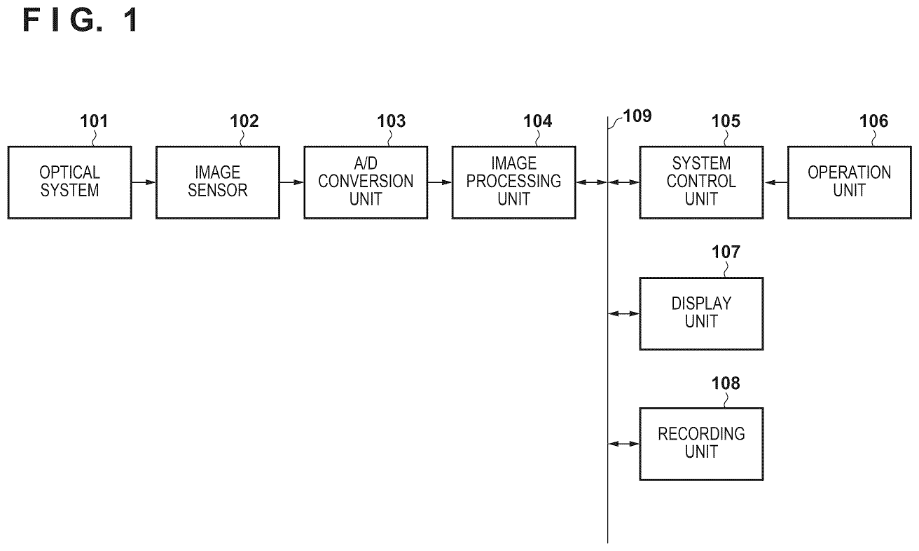

FIG. 1 is a block diagram illustrating a functional configuration of an image capturing apparatus equipped with an image processing apparatus according to a first embodiment.

In FIG. 1, an optical system 101 includes a lens group consisting of a plurality of lenses including a zoom lens and a focus lens, an aperture adjustment device, and a shutter device. The optical system 101 adjusts magnification, focus position, and light amount of an image of a subject to be incident on an image sensor 102. The optical system 101 may be formed integrally with the image capturing apparatus or may be configured to be detachable.

The image sensor 102 is a photoelectric conversion element such as a CCD or CMOS sensor that photoelectrically converts the light flux from the subject that has passed through the optical system 101 into an electrical signal.

An A/D conversion unit 103 converts the image signal input from the image sensor 102 into a digital image signal. An image processing unit 104 performs by-region tone correction processing in addition to normal signal processing. The by-region tone correction processing will be described in detail later. Note that the image processing unit 104 can perform similar processing not only on an image output from the A/D conversion unit 103, but also on an image read out from a recording unit 108.

A system control unit 105 supervises the operation and control of the entire image processing apparatus of this embodiment. It also controls actuations of the optical system 101 and the image sensor 102 based on a luminance value obtained from the image processed by the image processing unit 104 and instructions sent from an operation unit 106.

A display unit 107 is configured with a liquid crystal display, an organic Electro Luminescence (EL) display, or the like, and displays an image generated by the image sensor 102 or an image read from the recording unit 108. The recording unit 108 has a function of recording an image, and may include an information recording medium using, for example, a memory card equipped with a semiconductor memory or a package containing a rotating recording medium such as a magneto-optical disk, or the like, and the information recording medium may be configured removable. A bus 109 is used to exchange images and various information between the image processing unit 104, the system control unit 105, the display unit 107, and the recording unit 108.

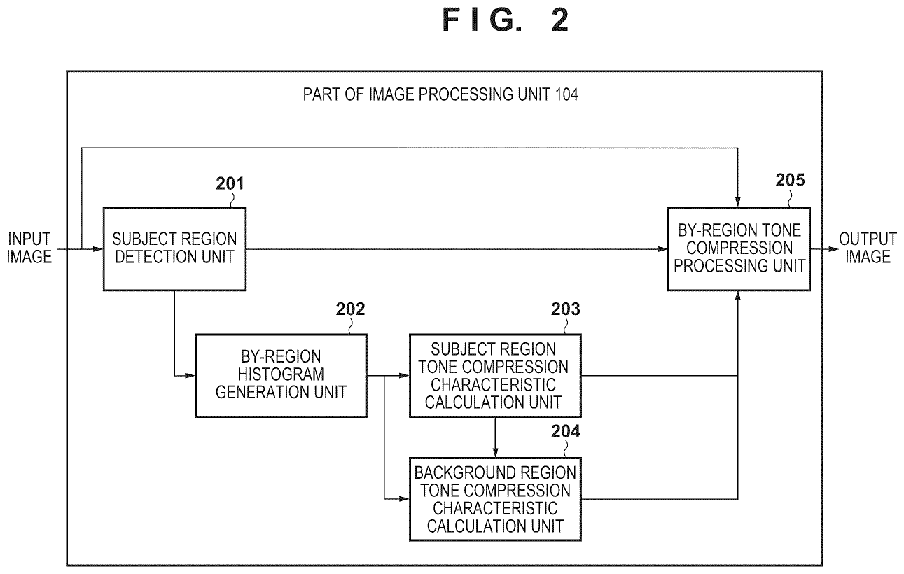

FIG. 2 is a block diagram illustrating a specific functional configuration related to the by-region tone correction processing performed in the image processing unit 104.

As shown in FIG. 2, the functional configuration related to the by-region tone correction processing within the image processing unit 104 includes a subject region detection unit 201, a by-region histogram generation unit 202, a subject region tone compression characteristic calculation unit 203, a background region tone compression characteristic calculation unit 204, and a by-region tone compression processing unit 205.

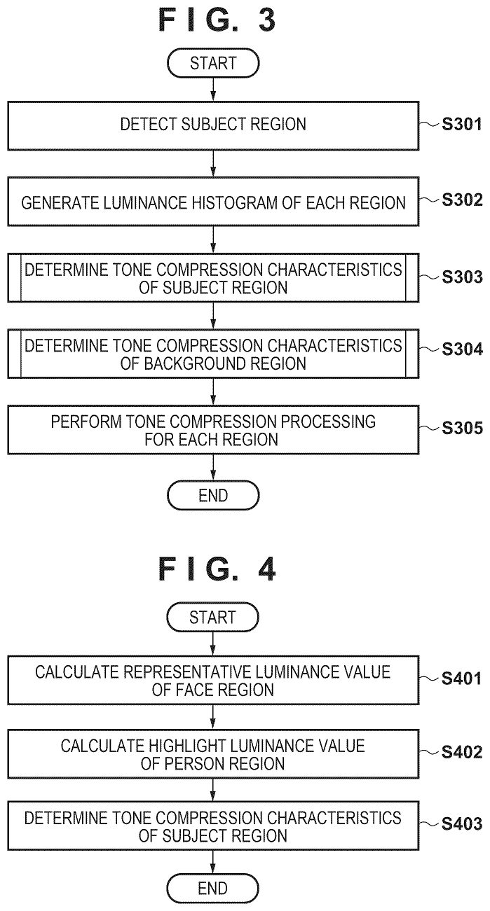

FIG. 3 is a flowchart showing the by-region tone correction processing according to this embodiment performed by the image processing unit 104 having the above configuration. Hereinafter, the by-region tone correction processing according to the first embodiment will be described with reference to the functional configuration shown in FIG. 2 and the flowchart of FIG. 3.

In step S301, the subject area detection unit 201 detects a subject area which is a target of detection from an input image using predetermined conditions. In this embodiment, a person region and a face region of a person included in the person region are detected, and the person region is classified as a subject region, and a region other than the person region is classified as a background region. Then, a region map is generated that indicates whether each pixel of the image belongs to the subject region or the background region. Note that the method for detecting the person region may be a known method such as object recognition using learning data by a neural network (for example, see Japanese Patent Laid-Open No. 2006-39666). In addition, the image used for detection may be a normal image taken under a proper exposure, or may be a so-called HDR image obtained by combining a plurality of images taken under different exposures such as a proper exposure, an underexposure, and an overexposure.

In step S302, the by-region histogram generation unit 202 uses the subject region detection results of the processing in step S301 to generate histograms (hereinafter referred to as “luminance histograms”) indicating the luminance distribution of the luminance signals of the person region, the face region, and the background region.

In step S303, the subject region tone compression characteristic calculation unit 203 calculates the tone compression characteristics of the subject region using the luminance histograms of the person region and the face region calculated in step S301.

Here, an example of a specific calculation method of the tone compression characteristics of the subject region performed by the subject region tone compression characteristic calculation unit 203 will be described with reference to the flowchart of FIG. 4.

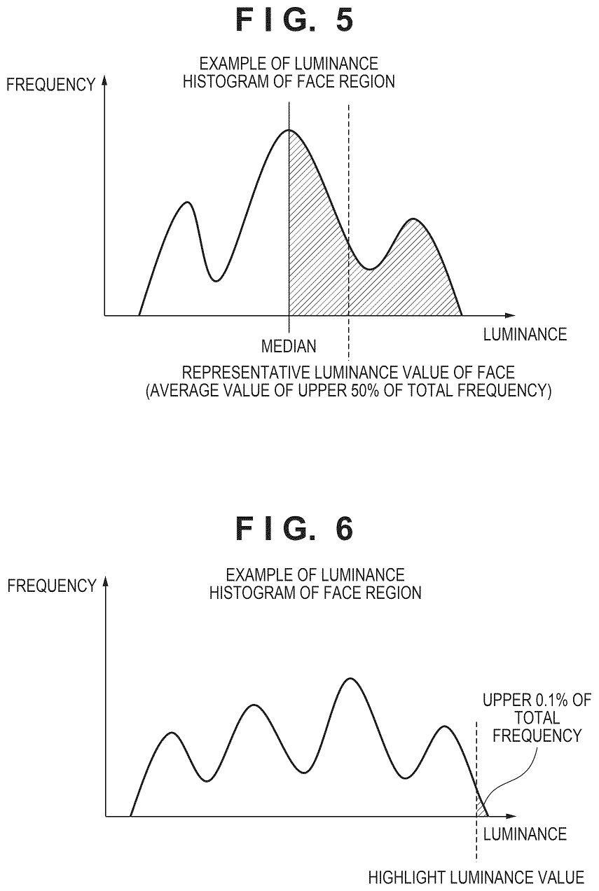

In step S401, a representative luminance value of the face region is calculated. FIG. 5 shows an example of a luminance histogram of the face region, and the shaded area shows the upper 50% of total frequency from the highest luminance value in the luminance histogram. In this embodiment, the average value of the luminance values of the upper 50% of total frequency from the highest luminance value is taken as the representative luminance value of the face. The reason for using the upper 50% of total frequency here is that in a case where there is a difference in luminance in the face region, such as in an oblique light scene, the luminance value of the bright side is taken as the representative luminance value to prevent the face from being corrected to be overly brightened. Also, instead of the upper 50% of total frequency, the representative luminance value may be calculated by another method, such as using the average value of the luminance values of the entire face region as the representative luminance value. Further, in the above example, the upper 50% of total frequency is used, but the percentage is not limited to this, and an arbitrarily predetermined percentage may be used.

In step S402, a highlight luminance value of the person region is calculated. FIG. 6 shows an example of a luminance histogram of the person region, and in this embodiment, the highlight luminance value is set to a luminance value at the upper 0.1% of total frequency from the highest luminance value in the luminance histogram of the person region. Note that in the above example, the upper 0.1% is used, but the percentage is not limited to this, and an arbitrarily predetermined percentage may be used.

In step S403, the tone compression characteristics of the person region are determined using the representative luminance value of the face region determined in step S401 and the highlight luminance value of the person region determined in step S402.

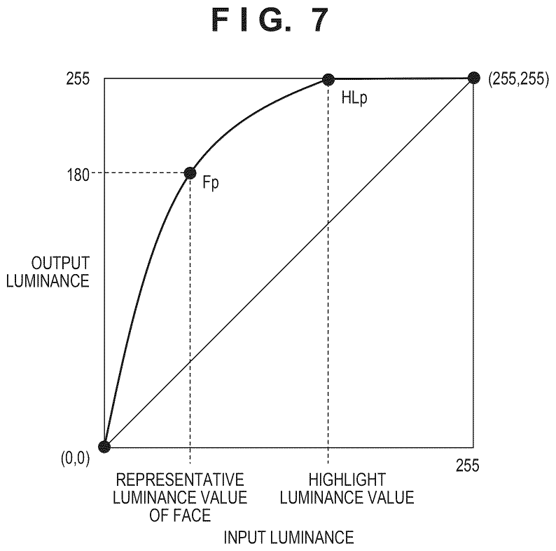

Here, a method for determining tone compression characteristics of a subject region will be described with reference to FIG. 7. FIG. 7 is a diagram showing an example of tone curve correction with the horizontal axis representing input luminance and the vertical axis representing output luminance, and the input luminance and output luminance are each expressed as 8-bit numerical values. As shown in FIG. 7, Fp (Face Point) is determined so that the output luminance value for the representative luminance value of the face is 180, and HLp (HighLight Point) is determined so that the output luminance value for the highlight luminance value is 255. Then, the points (0,0) and (255,255), Fp and HLp are connected to determine the tone compression characteristics.

If the tone compression characteristics are applied uniformly to the entire image, the output luminance value in the background region with luminance values higher than HLp will be saturated at 255, but in this embodiment, since it is applied only to the subject region, the output luminance value for the luminance range above HLp can be set to 255. On the other hand, since a large number of gradations can be assigned to luminance values in the luminance range below HLp, the subject region can be corrected while maintaining natural gradations. Also, other values may be used as the output luminance for Fp and HLp, and an upper limit may be set for the correction amount for Fp and HLp to suppress the deterioration of image due to noise caused by applying a gain.

Once the tone compression characteristics of the subject region is calculated as described above, the process returns to FIG. 3.

Next, in step S304, the background region tone compression characteristic calculation unit 204 calculates the tone compression characteristics of the background region using the luminance histogram of the background region calculated in step S301 and the tone compression characteristics of the subject region calculated in step S303.

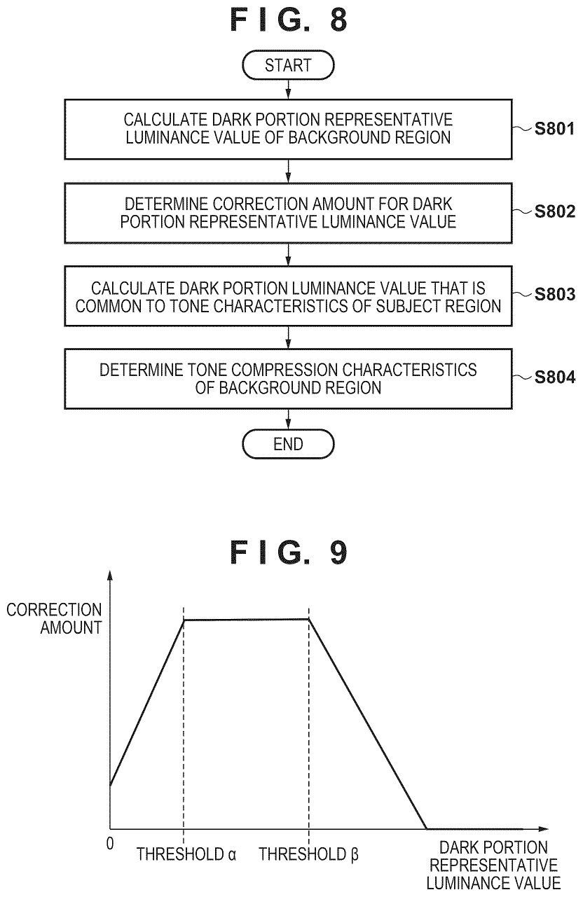

Here, an example of a specific method for calculating the tone compression characteristics of the background region performed by the background region tone compression characteristic calculation unit 204 will be described with reference to the flowchart of FIG. 8.

In step S801, a representative luminance value of a dark portion of the background region is calculated. In this embodiment, the average value of the luminance values of the lower 50% of total frequency from the lowest luminance value in the luminance histogram of the background region is taken as a dark portion representative luminance value of the dark portion. The reason for using the lower 50% of total frequency here is to detect the luminance value of the dark portion of the background and correct the luminance of that portion to be brighter. Note that in the above example, the lower 50% of total frequency is used, but the percentage is not limited to this, and an arbitrarily predetermined percentage may be used.

In step S802, a correction amount for the dark portion representative luminance value calculated in step S801 is determined. FIG. 9 is a diagram illustrating a correction table that is an example of the correction amount for the dark portion representative luminance value, and is prepared in advance. In this correction table, the correction amount is made small in a case where the dark portion representative luminance value is smaller than a threshold α, because there is a concern that overcorrection may occur if correction with a large correction amount is made to an originally small signal value. In addition, if the threshold for the dark portion representative luminance value is larger than the threshold β, need to correct the dark portion brighter decreases, so the correction amount is reduced.

Next, in step S803, a dark portion luminance value that is common to the tone characteristics of the subject region is calculated. This is because if the subject region and the background region have completely different gradation characteristics, it may result in an unnatural image that looks like the subject region and the background region are synthesized. By commonizing the tone characteristics of the dark portion and of the subject region, this unnaturalness can be alleviated.

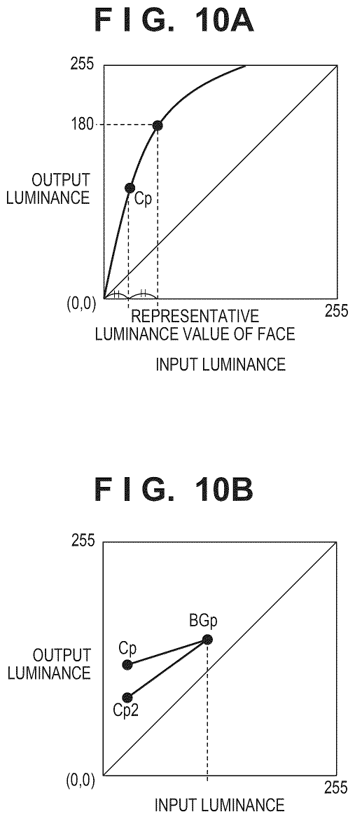

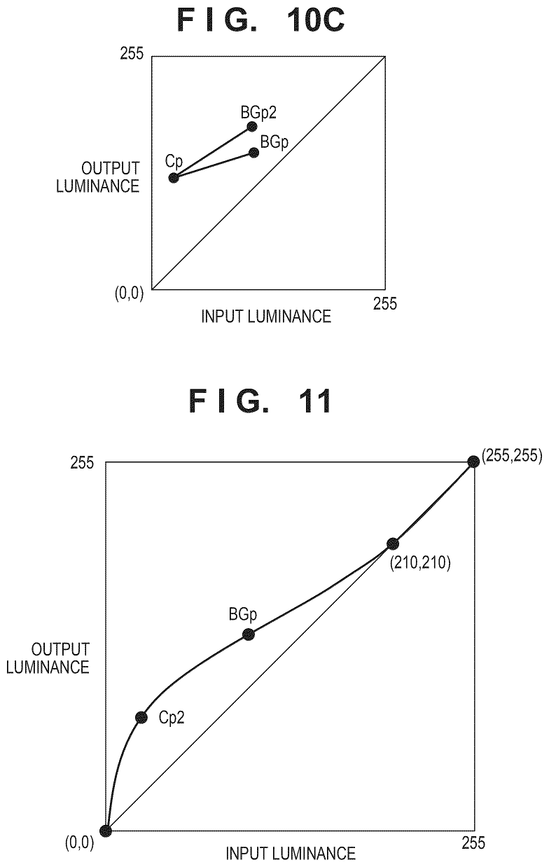

First, based on the tone compression characteristics of the subject region shown in FIG. 7 calculated in step S403, as shown in FIG. 10A, an output luminance value corresponding to a luminance value that is half the representative luminance value of the face is set as a common point Cp so as to be common to the tone characteristics of the subject region.

Next, this common point Cp is corrected to Cp2 as shown in FIG. 10B. In FIG. 10B, BGp (Background Point) is a point indicating a value obtained by correcting the dark portion representative luminance value of the background region calculated in step S801 using the correction value determined in step S802. If the slope of the line connecting Cp and BGp is smaller than a preset threshold, the point obtained by reducing the output luminance of Cp so that the slope becomes the threshold is set as Cp2. If the slope of the line connecting Cp and BGp is too small, the gradation characteristics of this range will be poor, so this processing is performed to secure the minimum slope. As another method, as shown in FIG. 10C, the correction amount may be changed to increase BGp without changing Cp, and point BGp2 may be obtained, or both Cp and BGp may be changed slightly.

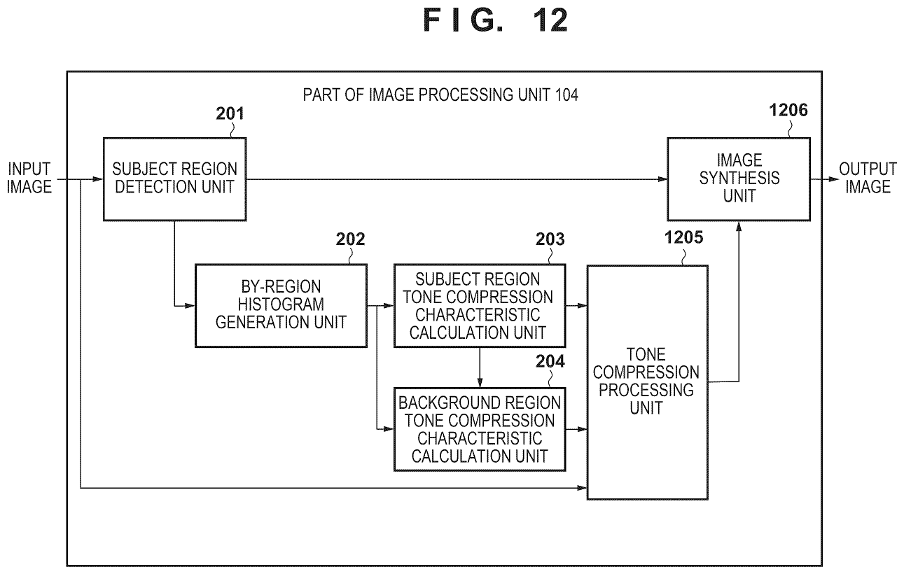

In step S804, the tone compression characteristics of the background region are determined using Cp or Cp2 and BGp2 or BGp determined in steps S801 to S803. FIG. 11 illustrates an example in which the tone compression characteristics are determined by connecting the points Cp2, BGp, (0,0), (210,210), and (255,255). Note that the point indicated by (210,210) indicates the luminance of a high luminance portion in the background such as the sky, and since it is often desirable to correct high luminance portions as little as possible, here the luminance of high luminance portions above 210 is not corrected.

Once the tone compression characteristics of the background region are calculated as described above, the process returns to the process in FIG. 3.

In step S305, the by-region tone compression processing unit 205 performs tone compression processing for each region using corresponding tone compression characteristics calculated for each region in steps S303 and S304 and the region map generated in step S301, and then ends the processing.

As described above, according to the first embodiment, in scenes with a wide dynamic range, it is possible to obtain an image with tone characteristics that can reduce saturation and blackout and that do not appear unnatural as a whole image.

### Second Embodiment

The second embodiment will be described below.

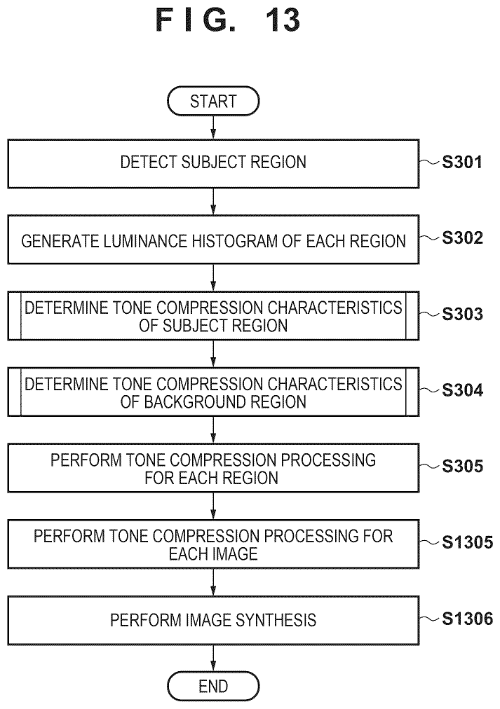

The configuration of the image capturing apparatus in the second embodiment is the same as that described in the first embodiment with reference to FIG. 1, and therefore a description thereof will be omitted. However, the functional configuration relating to by-region tone correction processing performed in the image processing unit 104 differs from that shown in FIG. 2, and therefore will be described with reference to FIG. 12.

FIG. 12 is a block diagram illustrating a specific functional configuration related to the by-region tone correction processing performed in the image processing unit 104 in the second embodiment. In the configuration shown in FIG. 12, the same reference numerals are used for the same components as those shown in FIG. 2, and the description thereof will be omitted. The image processing unit 104 in the second embodiment does not have the by-region tone compression processing unit 205, and instead, has a tone compression processing unit 1205 and an image synthesis unit 1206.

FIG. 13 is a flowchart showing the by-region tone correction processing in the second embodiment. Hereinafter, the by-region tone correction processing in the second embodiment will be described with reference to the functional configuration shown in FIG. 12 and the flowchart in FIG. 13. In addition, in the processes shown in FIG. 13, the same processes as those shown in FIG. 3 are given the same step numbers, and the description thereof will be omitted as appropriate.

In step S1305, the tone compression processing unit 1205 performs tone compression processing on an input image using the tone compression characteristics of the subject region obtained in step S303 and the tone compression characteristics of the background region obtained in step S304, to generate two kinds of image data.

Then, in step S1306, the image synthesis unit 1206 synthesizes the two image data generated in step S1305 using the region map generated in step S301 to generate one image in which tone correction has been performed for each region. Specifically, the image synthesis unit 1206 selects for the subject region an image signal that is tone-corrected using the tone compression characteristics of the subject region, and selects for the background region an image signal that is tone-corrected using the tone compression characteristics of the background region, thereby synthesizing an image.

As described above, according to the second embodiment, it is possible to obtain the same effects as those of the first embodiment.

In the above-described first and second embodiments, a case where the region is divided into two regions has been described in which a person's region is detected as the subject region, and the region other than the subject region is set as the background region. However, the present disclosure is not limited to this, and the image may be divided into a plurality of regions having different characteristics, and tone compression characteristics may be obtained based on the luminance histogram of each region. For example, two or more different types of subjects, such as a person, a vehicle, and an animal, may be detected, and tone compression characteristics of each subject region may be obtained.

Even in a case of dividing an image into three or more regions, it is possible to obtain an image with tone characteristics that do not appear unnatural as a whole by generating tone compression characteristics corresponding to the regions other than the reference subject region using tone compression characteristics (reference correction characteristics) corresponding to the reference subject region.

### Other Embodiments

The present disclosure may be applied to a system made up of a plurality of devices, or to a device made up of a single device.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-057615, filed Mar. 29, 2024 which is hereby incorporated by reference herein in its entirety.

What is claimed is:

1. An image processing apparatus, comprising at least one processor or circuit configured to function to:
acquire an image;
divide and classify the image into a plurality of regions based on predefined conditions;
determine correction characteristics for correcting tone characteristics for each of the plurality of regions; and
correct the tone characteristic of each of the regions using the correction characteristics corresponding to each of the regions,
wherein, in the determination, the correction characteristics corresponding to one of the plurality of regions that is used as a reference is set as a reference correction characteristics, and for the correction characteristics other than the reference correction characteristics, the correction characteristics of at least a portion that has a luminance lower than a predetermined luminance are determined based on the reference correction characteristics.

2. The image processing apparatus according to claim 1, wherein, in the determination, a luminance distribution of each of the regions is obtained, and the reference correction characteristics are determined based on a first representative luminance value obtained from the luminance distribution of the one region used as the reference.

3. The image processing apparatus according to claim 2, wherein, in the determination, the correction characteristics other than the reference correction characteristics are determined based on a second representative luminance value obtained from the luminance distribution of each region other than the one region used as the reference and the reference correction characteristics.

4. The image processing apparatus according to claim 3, wherein
in the classification, the image is classified into a subject region including a predetermined subject and a region other than the subject region, and
in the determination, the subject region is set as the one region used as the reference.

5. The image processing apparatus according to claim 4, wherein
the predetermined subject is a person, and
the first representative luminance value includes a first average value of luminance values within a predetermined first percentage from a highest luminance in a luminance distribution of a person's face region or of luminance values that constitute the luminance distribution, and a luminance value of a luminance at a predetermined second percentage from the highest luminance in the luminance distribution of the subject region.

6. The image processing apparatus according to claim 5, wherein
each region other than the one region used as the reference is a background region, and
the second representative luminance value includes a second average value of luminance values within a predetermined third percentage from a lowest luminance in the luminance distribution of the background region, and the first average value.

7. The image processing apparatus according to claim 1, wherein the correction characteristics other than the reference correction characteristics have a smaller correction amount for gradation characteristics in a high luminance portion than the reference correction characteristics.

8. The image processing apparatus according to claim 1, wherein
in the classification, a region map indicating types of the divided regions in the image is generated, and
in the correction, the tone characteristics of each of the regions is corrected using the correction characteristics corresponding to each of the regions based on the region map.

9. The image processing apparatus according to claim 1, wherein
in the classification, a region map indicating types of the divided regions in the image is generated, and
in the correction, tone characteristics of the image is corrected using each of a plurality of the correction characteristics, and resulting images are synthesized based on the region map.

10. The image processing apparatus according to claim 2, wherein, in the determination, with respect to the correction characteristics other than the reference correction characteristics, the correction characteristics of a luminance portion lower than the predetermined luminance are made to approach the reference correction characteristics, and the predetermined luminance is lower than the first representative luminance value.

11. The image processing apparatus according to claim 1, wherein, in the acquisition, a high dynamic range (HDR) image is obtained by combining a plurality of images taken with different exposures.

12. An image capturing apparatus comprising:
an image sensor; and
an image processing apparatus, comprising at least one processor or circuit configured to function to:
acquire an image;
divide and classify the image into a plurality of regions based on predefined conditions;
determine correction characteristics for correcting tone characteristics for each of the plurality of regions; and
correct the tone characteristic of each of the regions using the correction characteristics corresponding to each of the regions,
wherein, in the determination, the correction characteristics corresponding to one of the plurality of regions that is used as a reference is set as a reference correction characteristics, and for the correction characteristics other than the reference correction characteristics, the correction characteristics of at least a portion that has a luminance lower than a predetermined luminance are determined based on the reference correction characteristics.

13. An image processing method comprising:
acquiring an image;
dividing and classifying the image into a plurality of regions based on predefined conditions;
determining correction characteristics for correcting tone characteristics for each of the plurality of regions; and
correcting the tone characteristic of each of the regions using the correction characteristics corresponding to each of the regions,
wherein, in the determining, the correction characteristics corresponding to one of the plurality of regions that is used as a reference is set as a reference correction characteristics, and for the correction characteristics other than the reference correction characteristics, the correction characteristics of at least a portion that has a luminance lower than a predetermined luminance are determined based on the reference correction characteristics.

14. A non-transitory computer-readable storage medium storing instructions that, when executed by one or more processors, cause the one or more processors to perform a method comprising:
acquiring an image;
dividing and classifying the image into a plurality of regions based on predefined conditions;
determining correction characteristics for correcting tone characteristics for each of the plurality of regions; and
correcting the tone characteristic of each of the regions using the correction characteristics corresponding to each of the regions,
wherein, in the determining, the correction characteristics corresponding to one of the plurality of regions that is used as a reference is set as a reference correction characteristics, and for the correction characteristics other than the reference correction characteristics, the correction characteristics of at least a portion that has a luminance lower than a predetermined luminance are determined based on the reference correction characteristics.
